(19) United States
(12) Patent Application Publication
(10) Pub. No.: US 2014/0055360 A1
(43) Pub. Date: Feb. 27, 2014

(54) INPUT SYSTEM AND METHOD FOR COMPUTER

(71) Applicant: Hon Hai Precision Industry Co., Ltd., New Taipei (TW)

(72) Inventor: HSIEN-CHUAN LIANG, New Taipei (TW)

(73) Assignee: HON HAI PRECISION INDUSTRY CO., LTD., New Taipei (TW)

(21) Appl. No.: 13/960,840

(22) Filed: Aug. 7, 2013

(30) Foreign Application Priority Data
Aug. 21, 2012 (TW) 101130326

(51) Int. Cl. G06F 3/02

(52) U.S. Cl. CPC G06F 3/021
USPC 345/168

(57) ABSTRACT

An input system for a computer includes a portable device and a conversion device connected between the computer and the portable device. The portable device generates control signals in the manner of a keyboard or mouse to invoke computer functions. When a format or protocol communication type between the portable device and conversion device is different from the communication type between the conversion device and the computer, the conversion device converts the control signals to converted signals in compliance with the existing communication type between the computer and the conversion device.

### BACKGROUND

1. Technical Field

The present disclosure relates to an input system for a computer.

2. Description of Related Art

A user may use a keyboard or a mouse to input instructions, to prompt a server to perform functions, such as testing the server. Because servers may be rack mounted and without a keyboard and mouse, a user must provide the keyboard or mouse to communicate with the server. Hence, it is inconvenient if not impossible to communicate with the server when a keyboard and mouse is not found.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an input system for a computer of the present disclosure, wherein the input system includes a portable device and a conversion device.

FIG. 2 is a block diagram of the portable device of FIG. 1, wherein the portable device includes a controller.

FIG. 3 is a block diagram of the controller of FIG. 2.

FIG. 4 is a block diagram of the conversion device of FIG. 1, wherein the conversion device includes a processor.

FIG. 5 is a block diagram of the processor of FIG. 4.

FIG. 6 is a flow chart of an input method for a computer of the present disclosure.

### DETAILED DESCRIPTION

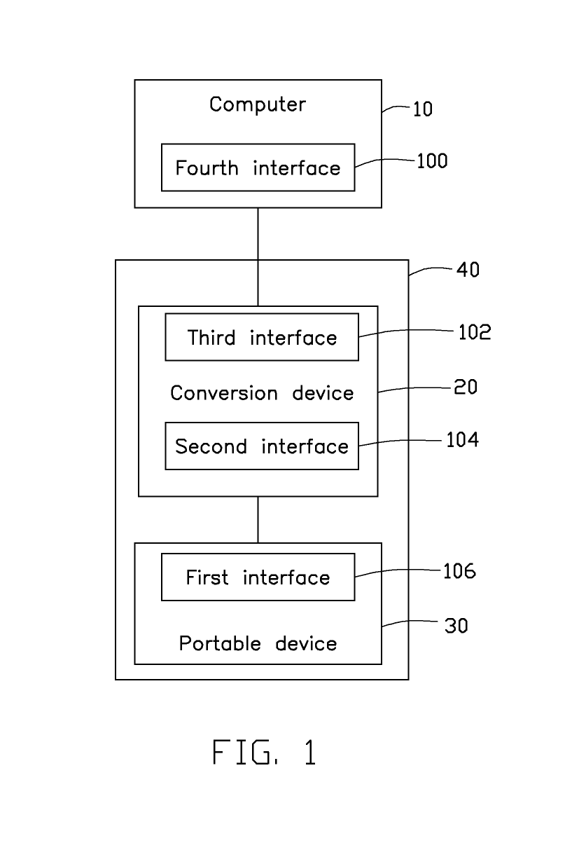

FIG. 1 illustrates an embodiment of an input system 40 for a computer 10. The input system 40 includes a portable device 30, and a conversion device 20 connected between the computer 10 and the portable device 30. The portable device 30 outputs control signals to the conversion device 20 to prompt the computer 10 to perform substantially all the functions that can be invoked by a mouse or keyboard. A user may take a portable device 30 anywhere in place of a keyboard and a mouse.

In the embodiment, the portable device 30 includes a first interface 106. The conversion device 20 includes a second interface 104 and a third interface 102. The computer 10 includes a fourth interface 100. The first interface 106 is connected to the second interface 104, the second interface 104 is connected to the third interface 102, and the third interface 102 is connected to the fourth interface 100. In the embodiment, both of the first and second interfaces 106 and 104 are universal serial bus (USB) interfaces. The third and fourth interfaces 102 and 100 may be USB interfaces, or other types of interfaces, such as personal system/2 (PS/2) interface.

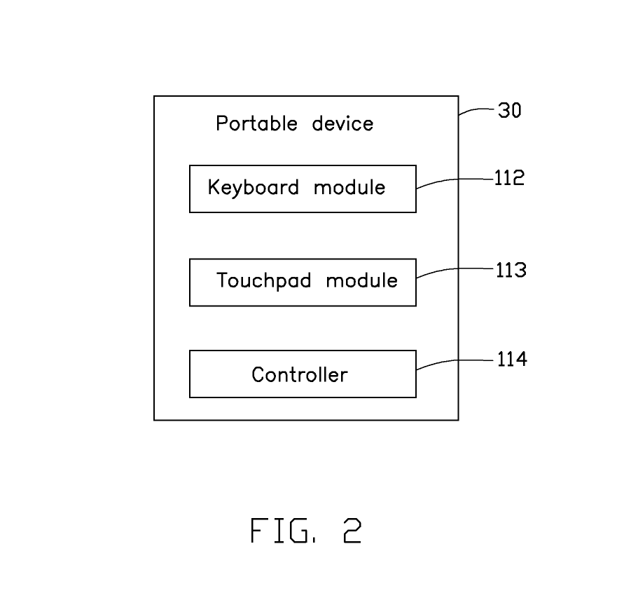

FIG. 2 shows that the portable device 30 further includes a keyboard module 112, a touchpad module 113, and a controller 114. The keyboard module 112 outputs key signals, such as outputting an “a” key signal when a key “A” of the keyboard module 112 is pressed. The touchpad module 113 outputs touching signals. For example, when a finger of a user swipes from right to left, the touchpad module 113 then generates a right-to-left swiping touching signal. The controller 114 is coupled to the keyboard module 112 and the touchpad module 113, to receive both types of the key signals and the touching signals. The controller 114 then generates control signals corresponding to the two types of key signals and the touching signals. In the embodiment, the portable device 30 is a laptop computer, where the keyboard module 112 is a keyboard of the laptop computer, the touchpad module 113 is a touchpad of the laptop computer, and the controller 114 is a central processing unit (CPU) of the laptop computer. In other embodiments, the portable device 30 may be a tablet computer, where a virtual keyboard, a touch screen, and a CPU of the tablet computer are respectively the keyboard module 112, the touchpad module 113, and the controller 114.

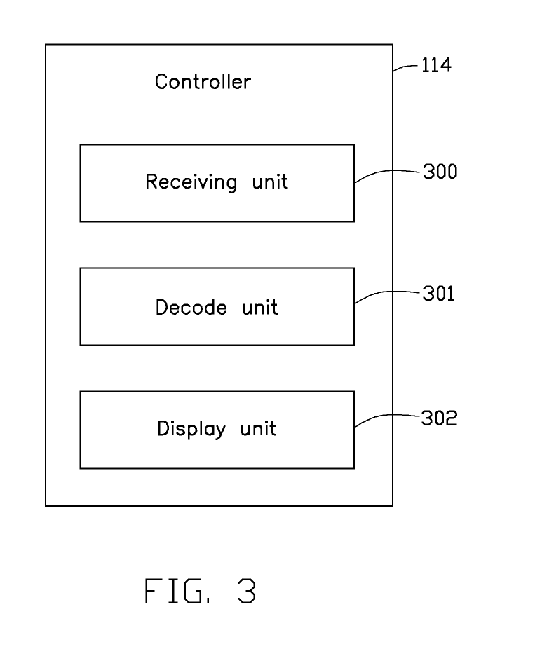

FIG. 3 shows that the controller 114 includes a receiving unit 300, a decode unit 301, and a display unit 302. The receiving unit 300 receives the key signals from the keyboard module 112 and the touching signals from the touchpad module 113. In the embodiment, the receiving unit 302 is an application program executed by the portable device 30. The decode unit 301 decodes both types of the key signals and the touching signals to generate the control signals corresponding to a communication type between the portable device 30 and the conversion device 20. The display unit 302 displays the cursor of the portable device 30.

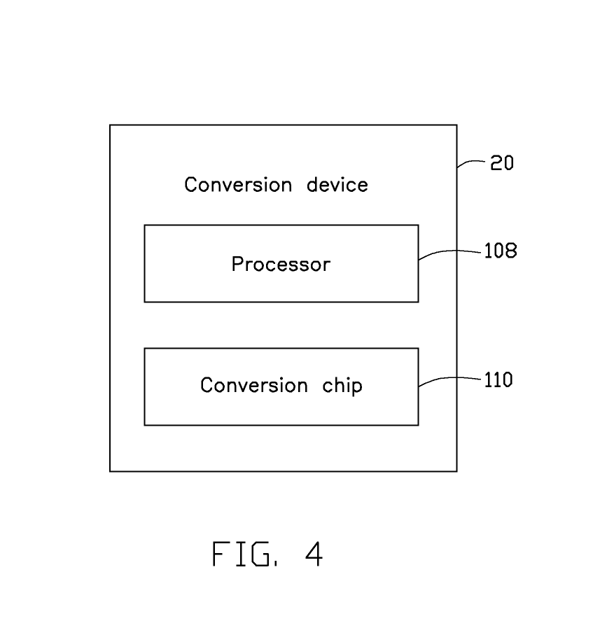

FIG. 4 shows that the conversion device 20 further includes a processor 108 and a conversion chip 110. The processor 108 receives the control signals transmitted by the portable device 20, and delivers the control signals to the computer 10 through the third and fourth interfaces 102 and 100. In another embodiment, if the format or protocol of the communication type between the third and fourth interfaces 102 and 100 is different from the format or protocol of the communication type between the first and second interfaces 106 and 104, the conversion chip 110 converts the control signals to converted signals in compliance with the formats or communication protocols which are recognized by both the third and fourth interfaces 102 and 100.

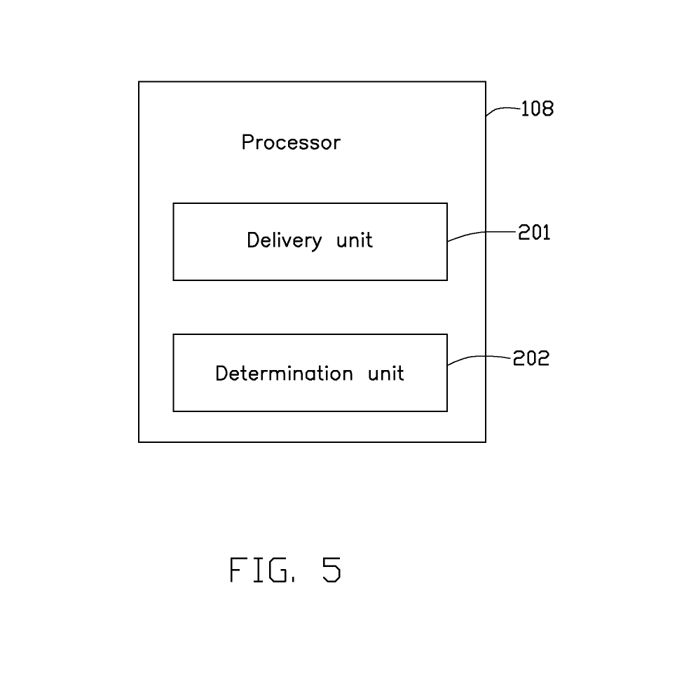

FIG. 5 shows that the processor 108 includes a delivery unit 201 and a determination unit 202. In other embodiments, the third and fourth interfaces 102 and 100 may be personal system/2 (PS/2) interfaces. The determination unit 202 determines the format and protocol communication type between the computer 10 and the conversion device 20. If the computer 10 communicates with the conversion device 20 through a USB interface, the determination unit 202 prompts the delivery unit 200 to transmit the control signals from the portable device 30 to the computer 10. Alternatively, if the determination unit 202 determines that format or protocol of communication type between the computer 10 and the conversion device 20 is the PS/2 interface, the determination unit 202 prompts the conversion chip 110 to convert the control signals from the portable device 10 to the converted signals, and then prompts the converted signals to be transmitted by the delivery unit 201 to the computer 10. In other embodiments, the conversion chip 110 may be implemented by an application program.

The computer 10 receives the control signals or the converted signals and functions accordingly.

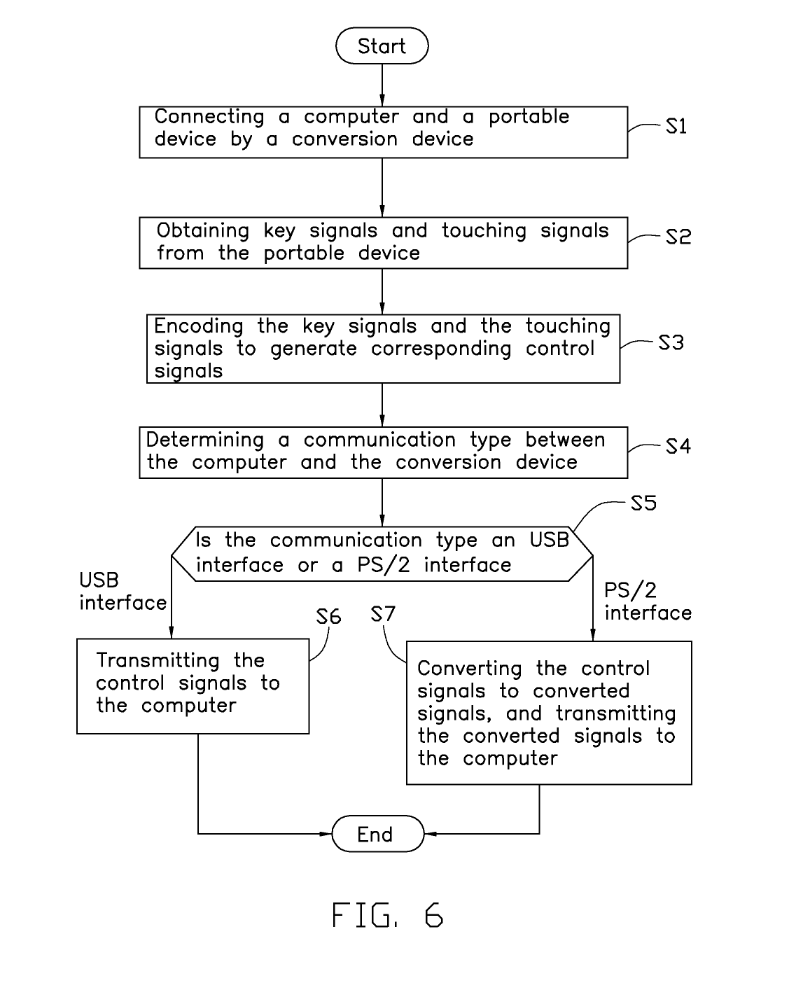

FIG. 6 shows an embodiment of an input method of the present disclosure. The input method includes steps below.

In step S1, the conversion device 20 is connected between the computer 10 and the portable device 30.

In step S2, the conversion device 20 obtains key signals and touching signals outputted by the portable device 30.

In step S3, the conversion device 20 encodes the key signals and the touching signals to generate corresponding control signals.

In step S4, the conversion device 20 determines the communication type between the computer 10 and the conversion device 20.

In step S5, the conversion device 20 determines whether the communication type between the computer 10 and the conversion device 20 is a USB interface. If the communication type between the computer 10 and the conversion device 20 is a USB interface, step S6 is implemented. If the communication type between the computer 10 and the conversion device 20 is a PS/2 interface, step S7 is implemented.

In step S6, the conversion device 20 transmits control signals to the computer 10.

In step S7, the conversion device 20 converts the control signals to converted signals, and transmits the converted signals to the computer 10.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An input system for a computer, comprising:
a portable device outputting a control signal through a first interface, the portable device comprising:
a keyboard module outputting a key signal;
a touchpad module outputting a touching signal; and
a controller connected to the keyboard module and the touchpad module, and comprising:
a receiving unit receiving the key signal and the touching signal; and
a decode unit decoding the key signal and the touching signal to generate the control signal; and
a conversion device comprising:
a second interface connected to the first interface of the portable device;
a third interface connected to a fourth interface of the computer; and
a processor comprising a delivery unit and a determination unit, wherein the determination unit determines communication types of the first and fourth interfaces, the delivery unit transmits the control signal from the portable device to the computer in response to the communication types of the first and fourth interfaces being the same.

2. The input system of claim 1, wherein the conversion device further comprises a conversion chip, wherein when the communication type between the first and the second interfaces is different from the communication type between the third and fourth interfaces, the converting chip converts the control signal to a converted signal complying with the communication type between the third interface and the fourth interface, and the delivery unit transmits the converted signal to the computer through the third and fourth interfaces.

3. The input system of claim 2, wherein the communication type between the first and the second interfaces is same with the communication type between the third and fourth interfaces, and the first to fourth interfaces are universal serial bus (USB) interfaces.

4. The input system of claim 2, wherein the communication type between the first and the second interfaces is different from the communication type between the third and fourth interfaces, and the first and second interfaces are universal serial bus (USB) interfaces, the third and fourth interfaces are person system/2 (PS/2) interfaces.

5. An input method for a computer, comprising:
connecting a portable device to the computer with a conversion device;
obtaining button signals and touching signals from the portable device by the conversion device;
decoding the button signals and the touching signals to generate control signals by the conversion device; and
transmitting the control signals to the computer through the conversion device.

6. The input method of claim 5, wherein the step “transmitting the controls signal to the computer” comprises:
determining communication type between the computer and the conversion device;
determining whether the communication type between the computer and the conversion device is same with the communication type between the conversion device and the portable device; and
transmitting the control signal to the computer in response to the communication type between the computer and the conversion device being same with the communication type between the conversion device and the portable device.

7. The input method of claim 6, further comprising:
converting the control signal to a converted signal by the conversion device in response to the communication type between the computer and the conversion device being different from the communication type between the conversion device and the portable device; and
transmitting the converted signal to the computer by the conversion device.
